(19) United States
(12) Patent Application Publication
(10) Pub. No.: US 2016/0204953 A1
(43) Pub. Date: Jul. 14, 2016

(54) NETWORK SYSTEM AND CONTROL METHOD THEREOF

(71) Applicant: LG ELECTRONICS INC., Seoul (KR)

(72) Inventors: Hwantae Kim, Seoul (KR); Wonchul Choi, Seoul (KR); Minhong Han, Seoul (KR)

(21) Appl. No.: 14/993,779

(22) Filed: Jan. 12, 2016

(30) Foreign Application Priority Data
Jan. 12, 2015 (KR) 10-2015-0004278

(51) Int. Cl. H04L 12/28; G05B 19/042; H04W 4/00

(52) U.S. Cl. CPC H04L 12/2816; H04W 4/005; G05B 19/042; G05B 2219/23238

(57) ABSTRACT

A network system including a first electric appliance having a memory unit and a second electric appliance to communicate with the first electric appliance, in which the second electric appliance includes a first memory unit storing software for monitoring an operation of the second electric appliance and a second memory unit storing software for managing operation information of the first electric appliance delivered from the first electric appliance.

### CROSS-REFERENCE TO RELATED APPLICATION(S)

This application claims priority under 35 U.S.C. §119 to Korean Application No. 10-2015-0004278, filed in Korea on Jan. 12, 2015, the entire disclosure of which is hereby incorporated by reference for all purposes.

### BACKGROUND

1. Field

A network system and a control method thereof are disclosed herein.

2. Background

Generally, home appliances include washing machines, refrigerators, kitchen electrics, and vacuum cleaners.

Recently, along with the development of communication technology, a plurality of home appliances are communicably connected to one another and are configured to use Internet of Things (IoT) technology to process information regarding functions of the appliances for themselves.

In particular, the plurality of home appliances may transmit and receive information through machine-to-machine (M2M) communication. For example, information regarding any one device may be transmitted to another device, and operation information of any one device may be checked through another device. Also, an operation of any one device may be controlled through another device.

A user may use a predetermined terminal to remotely monitor operation states of a plurality of home appliances connected to a network and control operations of the plurality of home appliances. As a network system of such home appliances is implemented, a more convenient smart home may be established by adding IT technology to a residential environment.

According to the related art (e.g., KR 10-2003-0093196), home appliances with high performance and comparatively high price are equipped with a memory in which a variety of software for communication is implemented to facilitate the smart home technology. Such home appliances include washing machines, refrigerators, air conditioners, and robot vacuum cleaners.

Conversely, home appliances with low performance and comparatively low price, that is, small home appliances, have limitations in being equipped with a memory in which the variety of software is implemented. As an example, small home appliances may include coffee makers, electrical outlets, light bulbs, driers, and mixers.

Accordingly, in the related art, there are limitations in incorporating the small home appliances into the home network to monitor the operation information of the small home appliances and control the operations of the small home appliances.

### SUMMARY

The present disclosure is directed to providing a network system with an improved convenience of use and a control method thereof.

One embodiment of the present invention provides a network system including a first electric appliance having a memory unit; and a second electric appliance to communicate with the first electric appliance, in which the second electric appliance includes a first memory unit in which software for monitoring an operation of the second electric appliance is stored; and a second memory unit in which software for managing operation information of the first electric appliance delivered from the first electric appliance is installed.

When the first electric appliance and the second electric appliance are communicably connected to each other, the operation information of the first electric appliance may be restricted from being stored in the memory unit and may be stored in the second memory unit.

The memory unit of the first electric appliance may include a first memory region in which software for controlling an operation of the first electric appliance and monitoring a state of the operation is stored; a second memory region in which software for performing a networking function of accessing the second electric appliance is stored; and a third memory region in which software for performing a function of delivering the operation information of the first electric appliance to the second electric appliance is stored.

The first memory unit may include a first memory region in which software for controlling an operation of the second electric appliance and monitoring a state of the operation is stored; a second memory region in which software for performing a networking function of accessing the second memory unit is stored; and a third memory region in which software for performing a function of delivering operation information of the second electric appliance to the second memory unit is stored.

The second memory unit may include a fourth memory region in which software for storing or managing data delivered from the memory unit of the first electric appliance or the first memory unit is stored.

The second memory unit may further include a fifth memory region in which software for performing a communication connection with the memory unit of the first electric appliance or the first memory unit is stored; and a sixth memory region in which software for setting a route for delivering a message between the memory unit of the first electric appliance and the first memory unit is stored.

The second electric appliance may be provided in a plurality, and the plurality of second electric appliances may perform machine-to-machine (M2M) communication.

The plurality of second electric appliances may form an arrangement of mesh topology in which the plurality of second electric appliances are individually and communicably connected.

The second memory unit may include a seventh memory region in which software for performing a function of processing protocol messages for communication with the plurality of second electric appliances is stored.

The network system may further include a mobile device to monitor the operation information of the first electric appliance or transmit a control command for operating the first electric appliance.

The control command of the mobile device may be transmitted to the second electric appliance, and the second electric appliance may transmit a message corresponding to the control command to the first electric appliance.

The first electric appliance may perform an operation corresponding to the message, sense a change in state caused by performing the operation, and transmit an update message for the changed state information to the second electric appliance, and the second electric appliance may transmit, to the mobile device, a response to a result of performing the control command and the update message of the first electric appliance.

The mobile device may request the operation information of the first electric appliance from the second electric appliance, and the second electric appliance may transmit the operation information of the first electric appliance stored in the second memory unit of the second electric appliance to the mobile terminal as a response.

The first electric appliance may be provided in a plurality, and the plurality of first electric appliances may be communicably connected to a communication module of the second electric appliance.

The first electric appliance may include an electric kettle, an outlet device, an illustration device, a hair dryer, and a mixer.

The second electric appliance may include a washing machine, a refrigerator, an air conditioner, a cooking device, a television, and a robot vacuum cleaner.

Another aspect of the present invention provides a control method of a network system, the control method including: communicably connecting a first electric appliance having a memory unit with a second electric appliance having a first memory unit and a second memory unit; transmitting a message for requesting state information of the first electric appliance or a control command of the first electric appliance from a mobile device while the first and second electric appliances are communicably connected; and transmitting a state information response message of the first electric appliance or a control result message of the first electric appliance from the second electric appliance to the mobile device.

The second electric appliance may be provided in a plurality, and the communicably connecting of the first and second electric appliances may include transmitting a communication access request message from the first electric appliance to the plurality of second electric appliances; transmitting response messages including communication access information from the plurality of second electric appliances; and communicably connecting the first electric appliance with a second electric appliance that transmits an earliest arriving response message.

The control method may further include: requesting, by the mobile device, the operation information of the first electric appliance from the second electric appliance; and transmitting, by the second electric appliance, the operation information of the first electric appliance stored in the second memory unit to the mobile terminal as a response.

The first electric appliance may be a small home appliance.

The plurality of second electric appliances form a machine-to-machine (M2M) communication network.

### BRIEF DESCRIPTION OF THE DRAWINGS

Embodiments will be described in detail with reference to the following drawings in which like reference numerals refer to like elements, and wherein:

FIG. 1 is a diagram showing a configuration of a network system according to a first embodiment of the present invention;

FIG. 2 is a block diagram showing the configuration of the network system according to the first embodiment of the present invention;

FIG. 3 is a block diagram showing a configuration of a first communication module according to the first embodiment of the present invention;

FIG. 4 is a block diagram showing a configuration of a second communication module according to the first embodiment of the present invention;

FIG. 5 is a flowchart showing establishment of communication between a first electric appliance and a second electric appliance according to the first embodiment of the present invention;

FIG. 6 is a flowchart showing a control method among the first electric appliance, the second electric appliance, and a mobile device according to the first embodiment of the present invention; and

FIG. 7 is a block diagram showing a configuration of a network system according to a second embodiment of the present invention.

### DETAILED DESCRIPTION

Hereinafter, embodiments of the present invention will be described in detail with reference to the accompanying drawings. In adding reference numerals for elements in each figure, it should be noted that like reference numerals are used to denote like elements in other figures wherever possible. Moreover, detailed descriptions related to well-known functions or configurations will not be described in order not to unnecessarily obscure subject matters of the present invention.

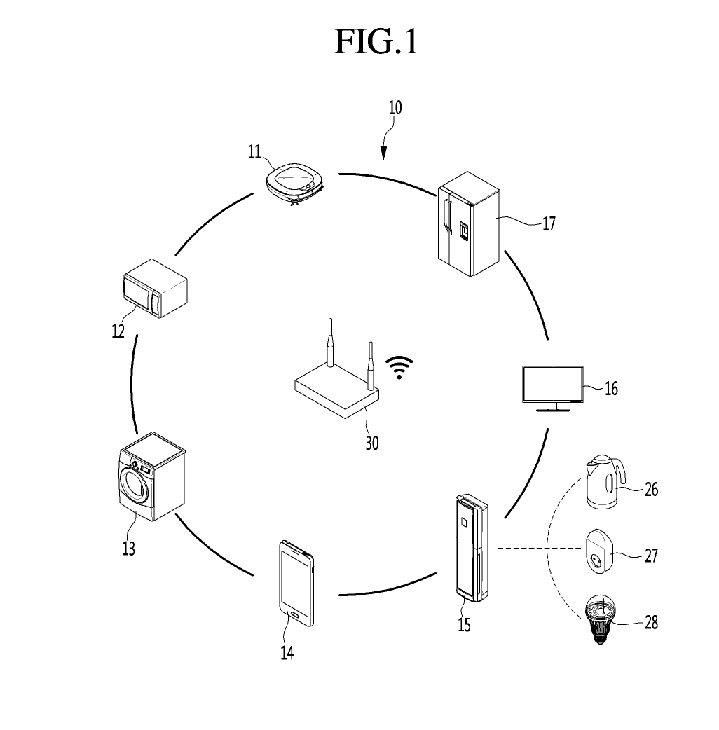

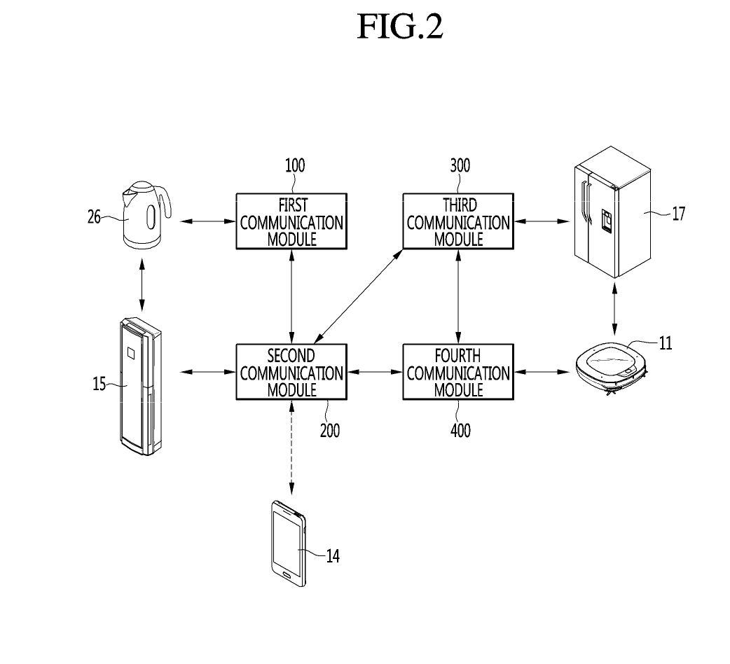

FIG. 1 is a diagram showing a configuration of a network system according to a first embodiment of the present invention, and FIG. 2 is a block diagram showing the configuration of the network system according to the first embodiment of the present invention.

Referring to FIGS. 1 and 2, a network system 10 according to the first embodiment of the present invention includes a plurality of electric appliances 11, 12, 13, 14, 15, 16, 17, 26, 27, and 28 that are communicably connected with each other.

In detail, the plurality of electric appliances 11, 12, 13, 14, 15, 16, 17, 26, 27, and 28 include first electric appliances 26, 27, and 28 having relatively low performance and second electric appliances 11, 12, 13, 14, 15, 16, and 17 having relatively high performance. The performance may include a capacity of a memory device capable of storing predetermined information.

First electric appliances 26, 27, and 28 may be referred to as small home appliances. As an example, first electric appliances 26, 27, and 28 may include an electric kettle 26, an outlet device 27, and an illumination device 28. However, first electric appliances 26, 27, and 28 are not limited thereto and may include a hair dryer and a mixer. First electric appliances 26, 27, and 28 are cheap functional products, and thus have limitations in increasing performance (memory capacity) over a predetermined value.

Second electric appliances 11, 12, 13, 14, 15, 16, and 17 are expensive functional products, and thus may increase the performance (memory capacity) over the predetermined value. As an example, second electric appliances 11, 12, 13, 14, 15, 16, and 17 may include a robot vacuum cleaner 11, a cooking device 12, a washing machine 13, a mobile device 14, an air conditioner 15, a television 16, and a refrigerator 17.

A plurality of second electric appliances 11, 12, 13, 14, 15, 16, and 17 may form a network through machine-to-machine (M2M) communication and may communicate with each other by wire or wirelessly.

For example, the plurality of second electric appliances 11, 12, 13, 14, 15, 16, and 17 may be communicably connected via a router over a WiFi connection. However, the communication method is not limited thereto. As long as the plurality of second electric appliances 11, 12, 13, 14, 15, 16, and 17 may form a network, another communication method, that is, Bluetooth, Ad-hoc, Zigbee, etc. may be used.

First electric appliances 26, 27, and 28 may be incorporated into network system 10 by accessing any one second electric appliance among the plurality of second electric appliances 11, 12, 13, 14, 15, 16, and 17.

State information or operation information of first electric appliances 26, 27, and 28 may be transmitted to the accessed second electric appliance, and an external apparatus may monitor or control first electric appliances 26, 27, and 28 through the accessed second electric appliance. The external apparatus includes the remaining second electric appliances other than the accessed second electric appliance among the plurality of second electric appliances 11, 12, 13, 14, 15, 16, and 17.

Referring to FIG. 2, network system 10 according to the first embodiment of the present invention includes first electric appliance 26 and a first communication module 100 configured to transmit the state information or operation information of first electric alliance 26 to other devices. FIG. 2 shows an electric kettle as an example of first electric appliance 26. First communication module 100 may be built-in to first electric appliance 26 or removably provided to the first electric appliance 26.

Network system 10 includes any one second electric appliance 15 and a second communication module 200 provided to communicate with first communication module 100 and receive the state information or operation information of first electric appliance 26. FIG. 2 shows air conditioner 15 as an example of second electric appliance 15, but is not limited thereto. Second communication module 200 may be built-in to second electric appliance 15 or removably provided to the second electric appliance 15, and may store the state information or operation information of second electric appliance 15.

Network system 10 includes another second electric appliance 17 and a third communication module 300 provided to communicate with second communication module 200. FIG. 2 shows refrigerator 17 as an example of second electric appliance 17, but is not limited thereto. Third communication module 300 may be built-in to second electric appliance 17 or removably provided to the second electric appliance 17, and may store the state information or operation information of second electric appliance 17.

Second communication module 200 and third communication module 300 may have the same configuration. Through the communication between second communication module 200 and third communication module 300, the state information or operation information of second electric appliance 15 may be transmitted to second electric appliance 17, and the state information or operation information of second electric appliance 17 may be transmitted to second electric appliance 15.

Network system 10 includes still another second electric appliance 11 and a fourth communication module 400 provided to communicate with second communication module 200 and third communication module 300. FIG. 2 shows robot vacuum cleaner 11 as an example of second electric appliance 11, but is not limited thereto. Fourth communication module 400 may be built-in to second electric appliance 11 or removably provided to the second electric appliance 11, and may store the state information or operation information of second electric appliance 11.

Fourth communication module 400 may have the same configuration as second communication module 200 and third communication module 300. Through the communication among second communication module 200, third communication module 300, and fourth communication module 400, the state information or operation information of second electric appliance 11 may be transmitted to second electric appliance 15 or 17, and the state information or operation information of second electric appliance 15 or 17 may be transmitted to second electric appliance 11.

According to the above-described configuration, network system 10 may form an arrangement of mesh topology in which the plurality of second electric appliances 11, 15, and 17 are individually and communicably connected.

Network system 10 may further include mobile device 14 operable by a user to check the state information or operation information of first electric appliance 26 and control an operation of first electric appliance 26. Mobile device 14 may include a smartphone configured to execute an application.

When the application is executed, mobile device 14 may access second communication module 200 and may monitor the state information or operation information of first electric appliance 26 stored in second communication module 200.

The user may use mobile device 14 to transmit a control command for operating first electric appliance 26 to second communication module 200, and second communication module 200 may transmit a message corresponding to the control commend to first communication module 100.

Detailed configurations of the first communication module and the second communication module will be described below with reference to the following drawings.

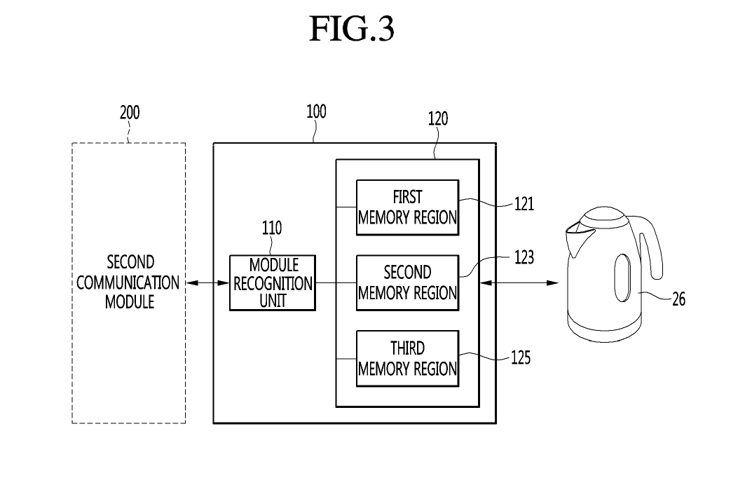

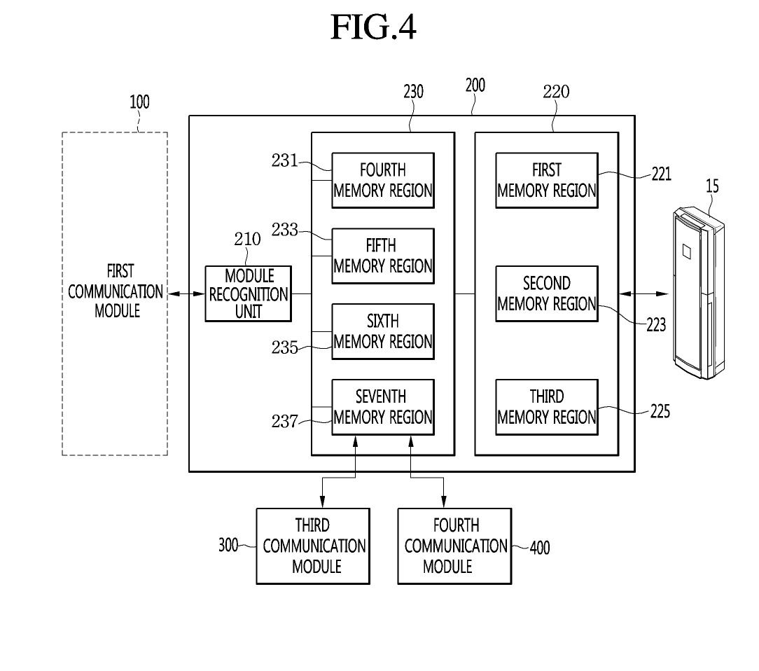

FIG. 3 is a block diagram showing a configuration of the first communication module according to the first embodiment of the present invention, and FIG. 4 is a block diagram showing a configuration of the second communication module according to the first embodiment of the present invention.

Referring to FIG. 3, first communication module 100 according to the first embodiment of the present invention includes a module recognition unit 110 configured to recognize second communication module 200. As an example, module recognition unit 110 may include a modem or an antenna.

First communication module 100 further includes a memory unit 120 configured to store information regarding first electric appliance 26. Memory unit 120 includes a plurality of memory regions 121, 123, and 125 in which a variety of software performing different functions is stored.

The plurality of memory regions 121, 123, and 125 include a first memory region 121 in which software that performs a function of controlling the operation of first electric appliance 26 and monitoring the operation state of first electric appliance 26 is stored, a second memory region 123 in which software that performs a networking function of accessing second electric appliance 15 is stored, and a third memory region 125 in which software that performs a function of delivering the operation information of first electric appliance 26 to second electric appliance 15 is stored.

The software stored in first memory region 121 may be referred to as a “device manager,” the software stored in second memory region 123 may be referred to as a “first connection manager,” and the software stored in third memory region 125 may be referred to as a “provisioning manager.”

While first electric appliance 26 is driven, the device manager may control the operation of first electric appliance 26. The first connection manager may search network system 10 for a second electric appliance that may be connected with first electric appliance 26 and access the second electric appliance. When the access to the second electric appliance is completed, the provisioning manager may transmit the operation information of first electric appliance 26 to second electric appliance 15.

Module recognition unit 110 and memory unit 120 may be integrated on one chip or provided separately.

Referring to FIG. 4, second communication module 200 according to the first embodiment of the present invention includes a module recognition unit 210 configured to recognize first communication module 100. As an example, module recognition unit 210 may include a modem or an antenna. For convenience of description, module recognition unit 110 may be referred to as a “first module recognition unit,” and module recognition unit 210 may be referred to as a “second module recognition unit.”

Second communication module 200 may further include a first memory unit 220 configured to store information regarding second electric appliance 15 and a second memory unit 230 communicably connected with first electric appliance 26 or configured to manage data delivered from first electric appliance 26.

First memory unit 220 includes a plurality of memory regions 221, 223, and 225 in which a variety of software performing different functions is stored.

The plurality of memory regions 221, 223, and 225 include a first memory region 221 in which software that performs a function of controlling the operation of second electric appliance 15 and monitoring the operation state of second electric appliance 15 is stored, a second memory region 223 in which software that performs a networking function of accessing second memory unit 230 to be described below is stored, and a third memory region 225 in which software that performs a function of delivering the operation information of second electric appliance 15 to second memory unit 230 is stored.

The software stored in first memory region 221 may be referred to as a “device manager,” the software stored in second memory region 223 may be referred to as a “first connection manager,” and the software stored in third memory region 225 may be referred to as a “provisioning manager.”

Second memory unit 230 includes a plurality of memory regions 231, 233, 235, and 237 in which a variety of software performing different functions is stored.

The plurality of memory regions 231, 233, 235, and 237 include a fourth memory region 231 in which software that stores or manages data delivered from memory unit 120 of first electric appliance 26 or first memory unit 220 is stored and a fifth memory region 233 in which software that performs a communication connection with memory unit 120 of first electric appliance 26 or first memory unit 220 is stored.

The plurality of memory regions 231, 233, 235, and 237 further include a sixth memory region 235 in which software that sets a route for delivering a message between memory unit 120 of first electric appliance 26 and first memory unit 220. It will be appreciated that the software stored in sixth memory region 235 may set a route for delivering a message between communication modules 200, 300, and 400 of the plurality of second electric appliances 11, 15, and 17.

The plurality of memory regions 231, 233, 235, and 237 further include a seventh memory region 237 in which software that performs a function of communicating with a plurality of second electric appliances 11 and 17, that is, a function of processing protocol messages for communication with third communication module 300 and fourth communication module 400. That is, a plurality of M2M communication protocols may be used by the software stored in seventh memory region 237.

The software stored in fourth memory region 231 may be referred to as a “data manager,” the software stored in fifth memory region 233 may be referred to as a “second connection manager,” the software stored in sixth memory region 235 may be referred to as a “routing manager,” and the software stored in seventh memory region 237 may be referred to as a “protocol manager.”

Module recognition unit 210 and first and second memory units 220 and 230 may be integrated on one chip or provided separately.

As such, second electric appliance 15 includes both of first and second memory units 220 and 230 and has high performance, thereby facilitating communication with the plurality of electric appliances. On the other hand, first electric appliance 26 includes only memory unit 120 and has relatively low performance, and thus has difficulty smoothly communicating with the plurality of electric appliances. Accordingly, according to the embodiment, first electric appliance 26 may be communicably connected to only one second electric appliance 15 among the plurality of electric appliances and networked.

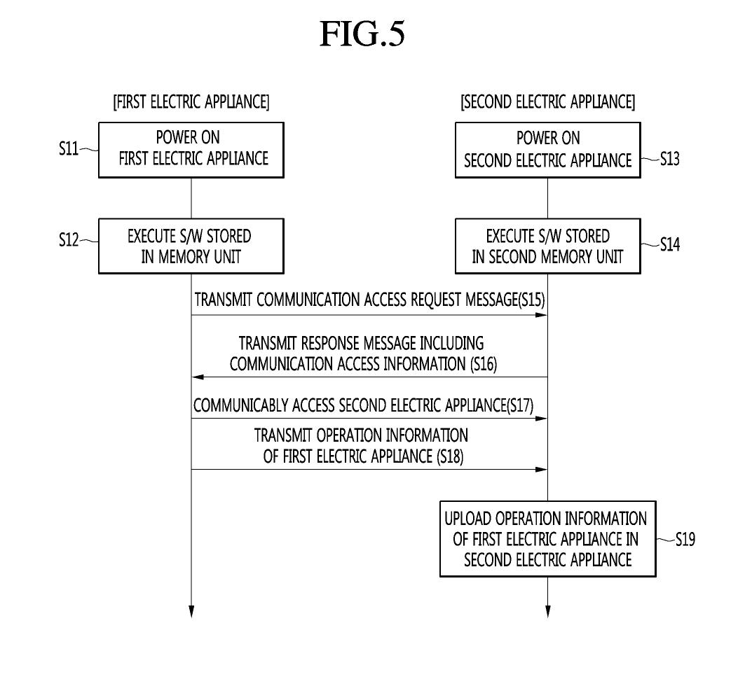

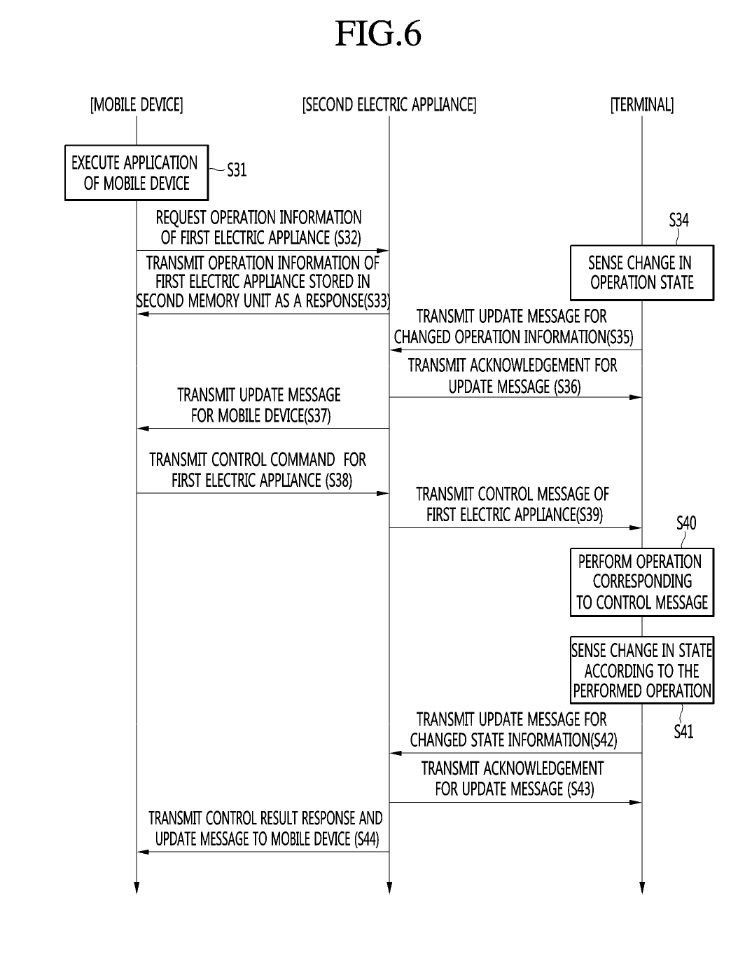

FIG. 5 is a flowchart showing establishment of communication between the first electric appliance and the second electric appliance according to the first embodiment of the present invention, and FIG. 6 is a flowchart showing a control method among the first electric appliance, the second electric appliance, and a mobile device according to the first embodiment of the present invention.

First, referring to FIG. 5, first electric appliance 26 is powered on (S11), and then software stored in memory unit 120 may be executed (S12). Second electric appliance 15 is powered on (S13), and then software stored in second memory unit 230 may be executed (S14).

The software stored in memory unit 120, particularly the first connection manager stored in second memory region 123, is executed to transmit a request message for communication access to second electric appliance 15, that is, second communication module 200.

In this case, the request message may be transmitted to a plurality of second electric appliances. That is, referring again to FIG. 2, the request message may be transmitted to the plurality of second electric appliances 11, 15, and 17.

When the request message is confirmed as being received, a communication module of each of the plurality of the second electric appliances 11, 15, and 17, particularly the second connection manager stored in fifth memory region 233 of second memory unit 230, transmits communication access information, for example communication IP and port information, to first electric appliance 26 as a response. First communication module 100 of first electric appliance 26 may access a communication module that has transmitted the earliest arriving response. FIG. 2 shows that the second electric appliance having transmitted the earliest arriving response is air conditioner 15 (S16, S17).

When second electric appliance 15 is accessed by first electric appliance 26, the operation information of first electric appliance 26 may be transmitted to second communication module 200 of second electric appliance 15 instead of being stored in first electric appliance 26 due to the limited performance (memory capacity) of the first electric appliance (S18).

Second communication module 200 of second electric appliance 15, particularly the data manager stored in fourth memory region 231 of second memory unit 230, may update or store the operation information of first electric appliance 26 (S19).

Referring to FIG. 6, while a communication connection is being established between first and second electric appliances 26 and 15 as described with reference to FIG. 5, an application may be executed by mobile device 14. It will be appreciated that the application is a program for transceiving information in order to network between first and second electric appliances 26 and 15 (S31).

Operation information of first electric appliance 26 may be requested from second electric appliance 15 through mobile device 14 (S32). As an example, a user may request the operation information by entering a predetermined input.

When the operation information is requested from second electric appliance 15, the operation information of first electric appliance 26 stored in second memory unit 230 of second electric appliance 15 may be transmitted to mobile device 14 as a response. That is, mobile device 14 may request the operation information not from first electric appliance 26 but from second electric appliance 15, and may receive the operation information of first electric appliance 26 previously stored in second electric appliance 15 as a reply (S33).

The state information or the operation information of first electric appliance 26 may change while first electric appliance 26 operates. First electric appliance 26 may sense the change through the device manager of memory unit 120, and the sensed operation information may be transmitted to second memory unit 230 of second electric appliance 15 in the form of an update message (S35).

Upon receiving the update message, second electric appliance 15 may transmit an acknowledgement message to first electric appliance 26 as a response (S36).

Second electric appliance 15 transmits the update message for the changed operation information of first electric appliance 26 to mobile device 14 (S37).

The user may use mobile device 14 to control the operation of first electric appliance 26. To this end, a control command for first electric appliance 26 may be transmitted from mobile device 14 to second electric appliance 15 (S38).

Upon receiving the control command from mobile device 14, second electric appliance 15 transmits a control message to first electric appliance 26 (S39). First electric appliance 26 may perform an operation according to the control message and may sense a change in state caused by performing the operation (S40, S41).

First electric appliance 26 may transmit an update message for the changed state information to second electric appliance 15 (S42), and second electric appliance 15 may receive the update message and then transmit an acknowledgement message to first electric appliance 26 as a response (S43).

Second electric appliance 15 may transmit, to mobile device 14, a response to a result of performing the control command and the update message of first electric appliance 26 (S44).

When the user intends to control first electric appliance 26 using mobile device 14, mobile device 14 need not directly communicate with first electric appliance 26, and may control first electric appliance 26 through second electric appliance 15. Accordingly, since first electric appliance 26 maintains only a communication connection with second electric appliance 15, first electric appliance 26 does not need a high-priced resource, for example, second memory unit 230.

The second embodiment of the present invention will be described below. Since the second embodiment is the same as the first embodiment except for some elements of the network system, differences therebetween will be mainly described, and the description and reference numerals of the first embodiment are applied to the same elements as those of the first embodiment.

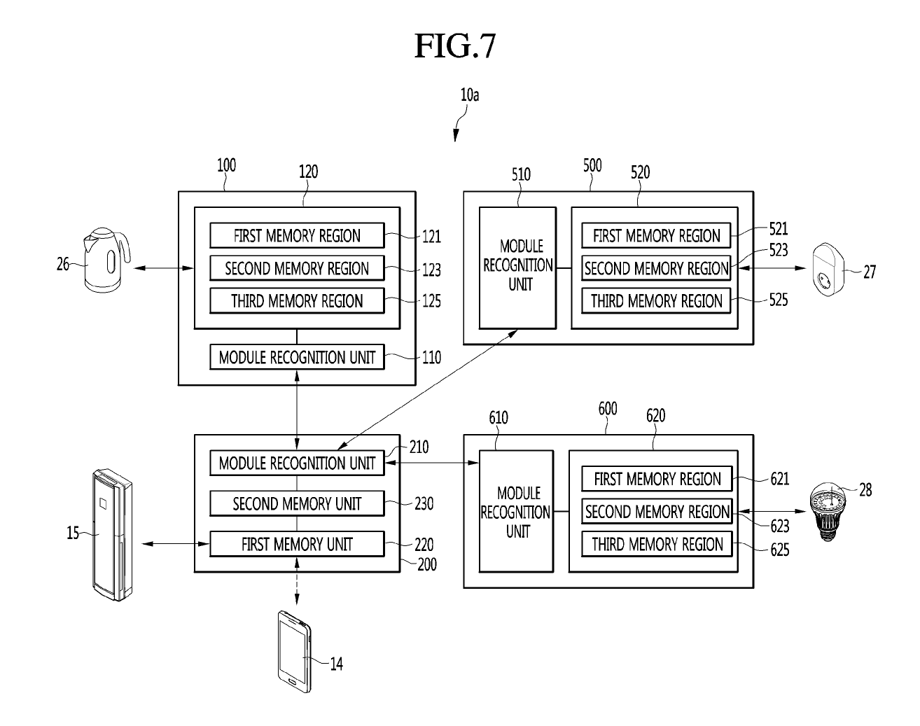

FIG. 7 is a block diagram showing a configuration of a network system according to a second embodiment of the present invention.

Referring to FIG. 7, a network system 10a according to the second embodiment of the present invention includes a second electric appliance 15 with high performance, that has a second communication module 200 including a first memory unit 220 and a second memory unit 230, and a plurality of first electric appliances 26, 27, and 28 with relatively low performance.

As an example, the plurality of first electric appliances 26, 27, and 28 may include an electric kettle 26, an outlet device 27, and an illumination device 28, but are not limited thereto.

Electric kettle 26 includes a first communication module 100. First communication module 100 includes a module recognition unit 110 and a memory unit 120. Memory unit 120 includes a first memory region 121, a second memory region 123, and a third memory region 125. The description of the first embodiment is applied to configurations of module recognition unit 110 and memory unit 120.

Outlet device 27 includes a fifth communication module 500. Fifth communication module 500 includes a module recognition unit 510 and a memory unit 520. Memory unit 520 includes a first memory region 521, a second memory region 523, and a third memory region 525. The configurations of module recognition unit 510 and memory unit 520 are the same as module recognition unit 110 and memory unit 120, and thus the detailed description thereof will be omitted.

Illumination device 28 includes a sixth communication module 600. Sixth communication module 600 includes a module recognition unit 610 and a memory unit 620. Memory unit 620 includes a first memory region 621, a second memory region 623, and a third memory region 625. The configurations of module recognition unit 610 and memory unit 620 are the same as module recognition unit 110 and memory unit 120, and thus the detailed description thereof will be omitted.

Module recognition unit 210 of second communication module 200, module recognition unit 110 of first communication module 100, module recognition unit 510 of fifth communication module 500, and module recognition unit 610 of sixth communication module 600 are communicably connected with one another.

Through communication between module recognition unit 210 of second electric appliance 15 and respective module recognition units 110, 510, and 610 of first electric appliances 26, 27, and 28, the operation information of first electric appliances 26, 27, and 28 may be stored or updated in first memory unit 220 or second memory unit 230 of second electric appliance 15.

When the user intends to monitor the operation information of first electric appliances 26, 27, and 28 and control first electric appliances 26, 27, and 28 through mobile device 14, mobile device 14 may access and communicate with second communication module 200 of second electric appliance 15 and may request the operation information of first electric appliances 26, 27, and 28 or transmit a control command through second communication module 200.

When the plurality of first electric appliances maintains a communication connection with the second electric appliance, the plurality of first electric appliances may easily respond to a request by an external device such as the mobile device even though the plurality of first electric appliances are not connected in communication with the external device.

According to the embodiments, it is possible to use a second electric appliance with high performance to monitor the operation information of the first electric appliance with low performance and control the operation of a first electric appliance.

In particular, it is also possible to enhance convenience of use in a home network since the operation information of the first electric appliance can be stored in the memory unit installed in the second electric appliance, and the user can use the mobile device to connect to the second electric appliance without connecting to the first electric appliance when the user intends to confirm the operation state of the first electric appliance.

It is also possible to incorporate a plurality of small home appliances into a home network since a plurality of electric appliances are communicably connected to one second electric appliance and operation information of the plurality of electric appliances can be stored in a memory unit of the second electric appliance.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A network system comprising:
a first electric appliance having a memory unit; and
a second electric appliance to communicate with the first electric appliance,
wherein the second electric appliance comprises:
a first memory unit storing software for monitoring an operation of the second electric appliance; and
a second memory unit storing software for managing operation information of the first electric appliance delivered from the first electric appliance.

2. The network system of claim 1, wherein, when the first electric appliance and the second electric appliance are communicably connected to each other, the operation information of the first electric appliance is stored in the second memory unit.

3. The network system of claim 1, wherein the memory unit of the first electric appliance comprises:
a first memory region storing software for controlling an operation of the first electric appliance and monitoring a state of the operation;
a second memory region storing software for performing a networking function of accessing the second electric appliance; and
a third memory region storing software for performing a function of delivering the operation information of the first electric appliance to the second electric appliance.

4. The network system of claim 1, wherein the first memory unit comprises:
a first memory region storing software for controlling an operation of the second electric appliance and monitoring a state of the operation;
a second memory region storing software for performing a networking function of accessing the second memory unit; and
a third memory region storing software for performing a function of delivering operation information of the second electric appliance to the second memory unit.

5. The network system of claim 1, wherein the second memory unit comprises a fourth memory region storing software for storing or managing data delivered from the memory unit of the first electric appliance or the first memory unit.

6. The network system of claim 5, wherein the second memory unit further comprises:
a fifth memory region storing software for performing a communication connection with the memory unit of the first electric appliance or the first memory unit; and
a sixth memory region storing software for setting a route for delivering a message between the memory unit of the first electric appliance and the first memory unit.

7. The network system of claim 1, further comprising:
a plurality of second electric appliances, each with a first and a second memory unit, and
wherein the plurality of second electric appliances performs machine-to-machine (M2M) communication.

8. The network system of claim 7, wherein the plurality of second electric appliances form an arrangement of mesh topology in which the plurality of second electric appliances are individually and communicably connected.

9. The network system of claim 7, wherein the second memory unit comprises a seventh memory region storing software for performing a function of processing protocol messages for communication with the plurality of second electric appliances.

10. The network system of claim 1, further comprising:
a mobile device to monitor the operation information of the first electric appliance or transmit a control command for operating the first electric appliance.

11. The network system of claim 10, wherein,
the control command of the mobile device is transmitted to the second electric appliance, and
the second electric appliance transmits a message corresponding to the control command to the first electric appliance.

12. The network system of claim 11, wherein,
the first electric appliance performs an operation corresponding to the message, senses a change in state caused by performing the operation, and transmits an update message for the changed state information to the second electric appliance, and
the second electric appliance transmits, to the mobile device, a response to a result of performing the control command and the update message of the first electric appliance.

13. The network system of claim 10, wherein,
the mobile device requests the operation information of the first electric appliance from the second electric appliance, and
the second electric appliance transmits the operation information of the first electric appliance stored in the second memory unit of the second electric appliance to the mobile terminal as a response.

14. The network system of claim 1, further comprising:
a plurality of first electric appliances, each with a memory unit, and
wherein the plurality of first electric appliances are communicably connected to a communication module of the second electric appliance.

15. The network system of claim 1, wherein the first electric appliance includes an electric kettle, an outlet device, an illustration device, a hair dryer, or a mixer.

16. The network system of claim 1, wherein the second electric appliance includes a washing machine, a refrigerator, an air conditioner, a cooking device, a television, or a robot vacuum cleaner.

17. A control method of a network system, the control method comprising:
communicably connecting a first electric appliance having a memory unit with a second electric appliance having a first memory unit and a second memory unit;
transmitting a message for requesting state information of the first electric appliance or a control command of the first electric appliance from a mobile device while the first and second electric appliances are communicably connected; and
transmitting a state information response message of the first electric appliance or a control result message of the first electric appliance from the second electric appliance to the mobile device.

18. The control method of claim 17, wherein,
the second electric appliance is provided in a plurality, and
the communicably connecting of the first and second electric appliances comprises:
transmitting a communication access request message from the first electric appliance to the plurality of second electric appliances;
transmitting response messages including communication access information from the plurality of second electric appliances; and
communicably connecting the first electric appliance with a second electric appliance that transmits an earliest arriving response message.

19. The control method of claim 17, further comprising:
requesting, by the mobile device, the operation information of the first electric appliance from the second electric appliance; and
transmitting, by the second electric appliance, the operation information of the first electric appliance stored in the second memory unit to the mobile terminal as a response.

20. The control method of claim 17, wherein the first electric appliance is a small home appliance.

21. The control method of claim 17, wherein the plurality of second electric appliances form a machine-to-machine (M2M) communication network.
